(19) United States
(12) Patent Application Publication
(10) Pub. No.: US 2025/0057160 A1
(43) Pub. Date: Feb. 20, 2025

(54) PHTHALIMIDE-BASED FUNGICIDE AND METHOD OF PREPARATION THEREOF

(71) Applicant: ADAMA MAKHTESHIM LTD., Beer Sheva (IL)

(72) Inventors: Boris RUBINOV, Beer Sheva (IL); Yehudah Rachamim WISEMAN, Carmit (IL)

(73) Assignee: ADAMA MAKHTESHIM LTD., Beer Sheva (IL)

(21) Appl. No.: 18/723,228

(22) PCT Filed: Dec. 21, 2022
(86) PCT No.: PCT/IL2022/051366

§ 371 Date: Jun. 21, 2024

Related U.S. Application Data
(60) Provisional application No. 63/293,135, filed on Dec. 23, 2021.

(51) Int. Cl. A01N 43/38; A01N 25/08; A01P 3/00

(52) U.S. Cl. CPC A01N 43/38; A01N 25/08; A01P 3/00

(57) ABSTRACT

The present invention provides a method for neutralizing the odor (purifying), of a technical phthalimide-based fungicide comprising (1) mixing (i) slurry of phthalimide-based fungicide in water with (ii) ammonium hydroxide solution, preferably followed by, (2) filtration of the phthalimide-based fungicide and (3) drying.

### RELATED APPLICATION/S

This application claims the benefit of priority of U.S. Provisional Patent Application No. 63/293,135 filed on 23 Dec. 2021, the contents of which are incorporated herein by reference in their entirety.

Throughout this application various publications are referenced. The disclosures of these documents in their entireties are hereby incorporated by reference into this application in order to more fully describe the state of the art to which this invention pertains.

### TECHNICAL FIELD

The present invention provides the use of ammonium hydroxide for neutralizing the odor of a phthalimide-based fungicide. Thus, the present invention provides inter alia, a method for neutralizing the odor of a phthalimide-based fungicide comprising contacting phthalimide-based fungicide in water with ammonium hydroxide. In particular a process is disclosed for neutralizing odor of a technical phthalimide-based fungicide comprising (1) mixing (i) phthalimide-based fungicide with (ii) ammonium hydroxide solution, typically in an aqueous slurry. This process can include the further steps of (2) filtration of the phthalimide-based fungicide and (3) drying.

### BACKGROUND

Captan, (N-(trichloromethylthio)-3a,4,7,7a-tetrahydrophthalimide, Captafol (N-[1,1,2,2-tetrachloroethylthiol]-4-cyclohexene-1,2-dicarboximide; and Folpet N-(Trichloromethylthio) phthalimide, are phthalimide-based fungicides having a broad spectrum fungicidal activity.

Some synthetic processes are known as disclosed in U.S. Pat. Nos. 2,553,770, 2,553,771, 2,553,776 and 3,314,969, where the process includes a reaction of phthalimide compound and derivative thereof with mercapto-based compound such as perchloromethyl mercaptan (PCMM) and pentachloroethyl mercaptan (PCEM)

To achieve high phthalimide-based fungicide assay and yield, reaction of the phthalimide and derivative thereof is conducted under basic conditions, with optionally, excess amount of mercapto based compound.

In some embodiments, the derivative of phthalimide is Tetrahydro phthalimide.

Mercapto-based compounds such as trichloromethane sulfenylchloride (perchloromethyl mercaptan) and residual compounds obtained during reaction thereof, are known for their foul, unbearable, acrid odor which cause the phthalimide-based fungicide to have unbearable, acrid odor.

In the art, different techniques are disclosed for controlling the odor.

GB1389031A discloses a reaction where a liquid is passed through a liquid-disintegrating mill in the course of the reaction so as to disintegrate microcrystalline agglomerates formed therein.

CN101624366B discloses transferring of the material to a purifying and temperature-rising processing kettle; heating and raising the temperature to 50-100 DEG C.; keeping the temperature for 0.5-5.0 hours”.

These treatments may perhaps increase product purity and eliminate some of the odor but have disadvantages such as yield reduction and possibly product degradation in some instances.

There is still a need to develop a simple, greener, and efficient process for neutralizing the mercapto material which remained in the phthalimide-based fungicide product after preparation.

### SUMMARY OF THE INVENTION

The present invention provides a method for neutralizing the odor of a phthalimide-based fungicide comprising contacting phthalimide-based fungicide in water with ammonium hydroxide.

The present invention provides a process for neutralizing the odor of a technical phthalimide-based fungicide comprising (1) mixing (i) phthalimide-based fungicide with (ii) ammonium hydroxide solution, typically in an aqueous slurry, and then optionally, the further steps of, (2) filtration of the phthalimide-based fungicide and (3) drying the filtrate to obtain a solid.

The present invention provides a process for the synthesis of phthalimide-based fungicide comprising: (1) obtaining phthalimide-based fungicide, (2) suspending the phthalimide-based fungicide in water. (3) mixing the suspension of (2) with ammonium hydroxide solution, typically followed by the steps of, (4) filtration of the phthalimide-based fungicide and (3) drying.

The present invention provides a method for neutralizing odor of a technical phthalimide-based fungicide comprising (1) mixing (i) slurry of phthalimide-based fungicide in water with (ii) ammonium hydroxide solution, (2) filtration of the phthalimide-based fungicide and (3) drying.

The present invention provides a filtered solid comprising a mixture of phthalimide-based fungicide and mercapto-based compound selected from a group consisting of PCMM and PCEM, and any combinations thereof, wherein the amount of mercapto based compound is less than 0.5% by weight based on the total amount of the filtered solid.

The present invention provides a combination comprising phthalimide-based fungicide and mercapto-based compound selected from a group consisting of PCMM and PCEM, and any combinations thereof, wherein the amount of mercapto based compound is less than 0.5% by weight based on the total amount of the combination.

The present invention provides the use of ammonium hydroxide solution for neutralizing odor of a technical phthalimide-based fungicide.

The present invention also provides a mixture of ammonium hydroxide and a phthalimide-based fungicide. In particular embodiments, the mixture is a dispersion, slurry, or suspension of particles of the phthalimide-based fungicide in a liquid comprising ammonium hydroxide, preferably in an aqueous slurry.

### DETAILED DESCRIPTION OF THE INVENTION

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

The term “a” or “an” as used herein includes the singular and the plural, unless specifically stated otherwise. Therefore, the terms “a,” “an,” or “at least one” can be used interchangeably in this application.

Throughout the application, descriptions of various embodiments use the term “comprising”; however, it will be understood by one of skill in the art, that in some specific instances, an embodiment can alternatively be described using the language “consisting essentially of” or “consisting of”. In each such instance, the terms “comprising.” “consisting essentially of.” and “consisting of” are intended to have the same meaning as each such term would have when used as the transition phrase of a patent claim.

For purposes of better understanding the present teachings and in no way limiting the scope of the teachings, unless otherwise indicated, all numbers expressing quantities, percentages, or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, use of the term “about” herein specifically includes ±10% from the indicated values in the range. In addition, the endpoints of all ranges directed to the same component or property herein are inclusive of the endpoints, are independently combinable, and include all intermediate points and ranges.

The present invention provides a process, which is suitable for industrial use, highly efficient, low-cost, and environmentally friendly.

It was found that contacting, mixing, etc., phthalimide-based fungicide with aqueous ammonium hydroxide, neutralizes and eliminates the foul-smell of mercapto-based compound and its residual compounds which results in a milder smell/odor of the technical phthalimide-based fungicide.

The present invention provides a method for neutralizing odor of a technical phthalimide-based fungicide comprising (1) mixing (i) slurry of phthalimide-based fungicide in water with (ii) ammonium hydroxide solution, and then optionally, (2) filtration of the phthalimide-based fungicide and (3) drying.

The present invention provides a process for the synthesis of phthalimide-based fungicide with reduced, or neutralized odor, comprising: (1) obtaining phthalimide-based fungicide, (2) suspending the phthalimide-based fungicide in water. (3) mixing the suspension of (2) with ammonium hydroxide solution, and then optionally. (4) filtration of the phthalimide-based fungicide and (5) drying.

Mercapto-based compound refers, but is not limited to perchloromethyl mercaptan (PCMM), pentachloroethyl mercaptan (PCEM).

In some embodiments, the mixture obtained after the reaction in which phthalimide-based fungicide is prepared, also comprises unknown or unidentified, mercapto-based residual compound(s) which effect the odor of the phthalimide-based fungicide which may be neutralized using ammonium hydroxide solution.

The term Phthalimide-based fungicide includes, but is not limited to folpet, captan and captafol.

The present invention provides a method for neutralizing odor of a technical phthalimide-based fungicide comprising (1) mixing phthalimide-based fungicide in solid form with (ii) ammonium hydroxide solution, and then optionally, (2) filtration and (3) drying.

In some embodiments, the phthalimide-based fungicide in solid form is first slurried in water.

In some embodiments, the phthalimide-based fungicide in form of a slurry is obtained by suspending a solid phthalimide-based fungicide in water prior to adding the ammonium hydroxide solution.

The present invention provides a method for neutralizing odor of a technical phthalimide-based fungicide comprising (1) mixing (i) a slurry of phthalimide-based fungicide in water, with (ii) ammonium hydroxide solution, preferably followed by the steps of (2) filtration and (3) drying.

The present invention provides a filtered solid mixture of phthalimide-based fungicide with mercapto-based compound selected from group consisting of PCMM; PCEM; and combinations thereof, wherein the amount of mercapto-based compound is less than 0.5% by weight based on the total amount of filtered solid.

The present invention provides the use of ammonium hydroxide solution for neutralizing odor of a phthalimide-based fungicide technical material or composition comprising it.

In some embodiments, the mercapto-based compound is perchloromethyl mercaptan (PCMM).

In some embodiments, the mercapto based compound is pentachloroethyl mercaptan (PCEM).

In some embodiments, the mercapto based compound is a mixture of mercapto based compound used for the reaction with phthalimide and residual compound(s).

In some embodiments, phthalimide-based fungicide is folpet.

In some embodiments, phthalimide-based fungicide is captan.

In some embodiments, phthalimide-based fungicide is captafol.

In some embodiments, the phthalimide-based fungicide is in the form of a liquid, preferably aqueous, slurry comprising the water-based reaction solution as obtained in the reaction for preparing the phthalimide-based fungicide.

In some embodiments, reaction solution is the carrier wherein the mercapto-based compound and phthalimide starting material are reacted for preparing the phthalimide-based fungicide.

In some embodiments, the carrier is water.

The present invention provides a method for purifying (odor neutralizing) phthalimide-based fungicide comprising (i) preparing an aqueous slurry comprising phthalimide-based fungicide and ammonium hydroxide and then optionally, (ii) filtering the solid technical phthalimide-based fungicide from the slurry and (iii) drying the filtrate.

In some embodiments, the mixing, contacting, or slurrying of phthalimide-based fungicide with ammonium hydroxide is at ambient temperature.

In some embodiments, the mixing etc., of phthalimide-based fungicide with ammonium hydroxide solution is at temperature of about 24° C.

In some embodiments, the mixing etc., of phthalimide-based fungicide with ammonium hydroxide is in at cold temperatures that are cooler than ambient.

In some embodiments, cooler temperature refers to a range of about 0-5° C.

In some embodiments, the mixing etc., of phthalimide-based fungicide with ammonium hydroxide solution, is at temperature of about 10-15° C.

In some embodiments, the concentration of ammonium hydroxide solution employed is about 1-25% by weight based on the total weight of the solution.

In some embodiments, the molar ratio between the mercapto-based material used for preparing the phthalimide-based fungicide to the ammonium hydroxide is at least 10:1.

In some embodiments, a slurry of the phthalimide-based fungicide is prepared by mixing phthalimide-based fungicide in solid, preferably particulate form with the ammonium hydroxide solution.

In some embodiments, the mixture of phthalimide-based fungicide and ammonium hydroxide is stirred or otherwise combined e.g., by agitation, for a time period exemplified by 1-10 min.

In some embodiments, the present invention is exemplified by a process for the synthesis of purified (odor neutralized), phthalimide-based fungicide wherein, said process comprises the steps: (1) reacting mercapto-based compound with phthalimide or phthalimide derivative(s) to obtain phthalimide-based fungicide, (2) mixing the phthalimide-based fungicide with ammonium hydroxide solution, and then optionally the steps of (3) filtration of the phthalimide-based fungicide and (4) drying.

In some embodiments the phthalimide-based fungicide used in step (2) is an aqueous suspension, preferably in water, that was obtained in step (1).

In some embodiments, the phthalimide-based fungicide used in step (2) is an aqueous suspension preferably in water, prepared by mixing phthalimide-based fungicide with water prior to step (2).

In an embodiment, step (1) is carried out in the presence of base.

In some embodiments, the invention is exemplified by a process for the synthesis of purified (odor neutralized), folpet, wherein, said process comprises the steps of (1) mixing the folpet with ammonium hydroxide solution, preferably followed by, (2) filtration of the folpet and (3) drying.

In some embodiments, the invention is exemplified by a process for the synthesis of purified (odor neutralized), captan, wherein, said process comprises the steps of (1) mixing the captan with ammonium hydroxide solution, preferably followed by, (2) filtration of the captan and (3) drying.

In some embodiments, the invention is exemplified by a process for the synthesis of N-(trichloromethylthio)-3a,4,7,7a-tetrahydrophthalimide, wherein, said process comprises the steps of (1) mixing the N-(trichloromethylthio)-3a,4,7,7a-tetrahydrophthalimide with ammonium hydroxide solution, preferably followed by, (2) filtration of the N-(trichloromethylthio)-3a,4,7,7a-tetrahydrophthalimide and (3) drying.

In some embodiments, the invention is a process for the synthesis of purified (odor neutralized), N-[1,1,2,2-tetrachloroethylthiol]-4-cyclohexene-1,2-dicarboximide, wherein, said process comprises steps of mixing the N-[1.1.2.2-tetrachloroethylthiol]-4-cyclohexene-1,2-dicarboximide with ammonium hydroxide solution, preferably followed by, (2) filtration of the N-[1,1,2,2-tetrachloroethylthiol]-4-cyclohexene-1,2-dicarboximide and (3) drying.

In some embodiments, the invention is a process for the synthesis of N-(Trichloromethylthio) phthalimide, wherein, said process comprises steps of mixing the N-(Trichloromethylthio) phthalimide with ammonium hydroxide solution, preferably followed by, (2) filtration of the N-(Trichloromethylthio) phthalimide and (3) drying.

In addition, please note, when lists are provided in this disclosure, the list is to be considered as a disclosure of each individual member in the list, independently of any of the others, typically organized in a list for convenience.

This invention will be better understood by reference to the Experimental Details which follow, but those skilled in the art will readily appreciate that the specific experiments detailed are only illustrative of the invention as described more fully in the claims which follow thereafter.

The invention is illustrated by the following examples without limiting it thereby.

### EXPERIMENTAL SECTION

### Materials and Methods

### Example 1, Process for Tests III-VI

Purification of captan at 0-5° C., preparation of phthalimide-based fungicide, captan.

151 gr (1 mol) of Tetrahydrophthalimide (THPI) are dissolved in 900 cc. of water containing 40 grams of NaOH (1 mole), at 0-5° C.

186 gr (110 mL) of PCMM (1 mole) and the THPI sodium salt solution are added in parallel into stirred reactor for 15 minutes, while the pH is maintained between pH 9 and pH 10.5. The temperature is maintained at 0-5° C. After completion of the reaction, 12.5 gr of 25% aqueous NH₄OH solution added (1 w/w % to total reaction mass, 0.1 mole) and stirred for 1-3 minutes. Reaction mixture is heated to 10-15° C., filtered and dried. Yield 85%, average of tests.

### Example 2, Process for Tests VIII-X

Purification of captan at 10-15° C., preparation of phthalimide-based fungicide, captan.

151 gr (1 mole) of Tetrahydrophthalimide (THPI) are dissolved in 900 cc. of water containing 40 grams of NaOH (1 mole), at 0-5° C.

186 gr (110 mL) of PCMM (1 mole) and THPI sodium salt solution are added in parallel into stirred reactor for 15 minutes, while the pH is maintained between pH 9 and pH 10.5. The temperature is maintained at 0-5° C. The slurry is heated to 10-15° C. 12.5 gr of 25% aqueous NH₄OH solution is added (1 w/w % to total reaction mass, 0.1 mole), stirred for 1-3 minutes, filtered and dried. Yield 84%, average of tests.

### Example 3: Process for Comparative Tests, I and VII—No Treatment with NH₄OH

151 gr (1 mol) of Tetrahydrophthalimide (THPI) are dissolved in 900 cc. of water containing 40 grams of NaOH (1 mole), at 0-5° C.

186 gr (110 mL) of PCMM (1 mole) and the THPI sodium salt solution are added in parallel into stirred reactor for 15 minutes, while the pH is maintained between pH 9 and pH 10.5. The temperature is maintained at 0-5° C. Reaction mixture is heated to 10-15° C., filtered and dried. Yield 85%, average of tests.

Test II was a comparative experiment-Treatment with NaOH instead of NH₄OH Results The products of process examples 1 and 2, had an insignificant odor, compared to the comparative tests.

Table 1, includes the results process wherein an aqueous ammonium hydroxide had been added at the end of the preparative reaction (at two sampling points) and stirred for odour neutralization. The solid product was obtained after filtration, washing, and drying. Treatment with diluted NaOH was performed as reference comparison process.

Also included are the results of Comparative Tests I and VII in table 1, which were prepared as described in example 3.

Tests II-VI in table 1, were conducted based on the procedure described in example 1 except that in comparative Test II, NaOH was used (unsuccessfully), instead of NH₄OH.

Examples VIII-X in table 1, were conducted based on the procedure described in example 2.

In all tests, the amount of mercapto-based compound starting material is 1 mol.

TABLE 1

| | Treatment | Treatment | | | | | |
|---|---|---|---|---|---|---|---|
| Test | Temp. | | [symbol] mount | Stirring time | pH | pH | |
| No. | (° C.) | Treatment | [symbol] mole) | (min) | initial | final | Odor |
| I | Comparative Test No Treatment | | | | 10.3 | 10.3 | Irritating |
| II | 0-5 | NaOH Comparison | 0.1 | 1 | 9.4 | 10.8 | Irritating |
| III | | NH₄OH | 0.1 | 1 | 10.0 | 11.1 | Not |
| | | | | | | | Irritating |
| IV | | NH₄OH | 0.2 | 1 | 9.2 | 11.3 | Not |
| | | | | | | | Irritating |
| V | | NH₄OH | 0.1 | 2 | 10.4 | 10.9 | Not |
| | | | | | | | Irritating |
| VI | | NH₄OH | 0.1 | 3 | 10.2 | 11.0 | Not |
| | | | | | | | Irritating |
| VII | Comparative Test No Treatment | | | | 9.5 | 9.5 | Irritating |
| VIII | 10-15 | NH₄OH | 0.1 | 1 | 9.3 | 10.8 | Not |
| | | | | | | | Irritating |
| IX | | NH₄OH | 0.1 | 2 | 8.2 | 10.8 | Not |
| | | | | | | | Irritating |
| X | | NH₄OH | 0.1 | 3 | 9.5 | 10.8 | Not |
| | | | | | | | Irritating |

[symbol]

indicates data missing or illegible when filed

Conclusion: Use of ammonium hydroxide neutralized the irritating odour.

What is claimed is:

1) A method for neutralizing odor of a phthalimide-based fungicide comprising contacting the phthalimide-based fungicide in water with ammonium hydroxide.

2) The method of claim 1 wherein the phthalimide-based fungicide is phthalimide-based fungicide technical material.

3) The method of any one of claims 1 and 2 comprising
a) Mixing,
(i) phthalimide-based fungicide in solid form, with
(ii) ammonium hydroxide solution, and
optionally followed by,
b) filtration, and
c) drying.

4) The method of any one of claims 1-3 comprising (1) mixing, (i) phthalimide-based fungicide in solid form with (ii) ammonium hydroxide solution, preferably followed by, (2) filtration and (3) drying.

5) The method of any one of claims 1-4, wherein the phthalimide-based fungicide is in the form of an aqueous slurry preferably a water slurry.

6) The method of claim 5, wherein the aqueous slurry in water is a slurry in the solution from the reaction that produced the phthalimide-based fungicide.

7) The method of claim 5, wherein the phthalimide-based fungicide in the form of a slurry is obtained by suspending a solid phthalimide-based fungicide in water prior to adding the ammonium hydroxide solution.

8) The method of any one of claims 1-7, wherein the phthalimide-based fungicide is folpet.

9) The method of any one of claims 1-7, wherein phthalimide-based fungicide is captan.

10) The method of any one of claims 1-7, wherein phthalimide-based fungicide is captafol.

11) The method of any one of claims 1-10, wherein the contacting is by mixing of phthalimide-based fungicide with ammonium hydroxide at ambient temperatures.

12) The method of any one of claims 1-10, wherein the contacting is by mixing of phthalimide-based fungicide with ammonium hydroxide is at a temperature of about 24° C.

13) The method of any one of claims 1-10, wherein the contacting is by mixing of phthalimide-based fungicide with ammonium hydroxide at cold temperatures exemplified by being below ambient.

14) The method of claim 13, wherein the cold temperature is a range of about 0-5° C.

15) The method of any one of claims 1-10 and 13, wherein the contacting is by mixing phthalimide-based fungicide with ammonium hydroxide solution at temperature of about 10-15° C.

16) The method of any one of claims 1-15, wherein the concentration of ammonium hydroxide solution is about 1-25% by weight based on the total weight of the solution.

17) The method of any one of claims 1-15, wherein the concentration of ammonium hydroxide solution is about 15% by weight based on the total weight of the solution.

18) The method of any one of claims 1-15, wherein the molar ratio between the mercapto-based material used in the reaction by which the phthalimide-based fungicide was prepared, to the ammonium hydroxide is at least 10:1.

19) The method of any one of claims 1-18, wherein the phthalimide-based fungicide and ammonium hydroxide in solution are contacted by stirring for about 1-10 min.

20) A combination of a phthalimide-based fungicide and a mercapto-based compound selected from group consisting of PCMM; PCEM; and any mixtures thereof, wherein the amount of mercapto based compound is less than 0.5% by weight based on the total amount of phthalimide-based fungicide and mercapto-based compound.

21) A filtered solid comprising a mixture of phthalimide-based fungicide with mercapto based compound selected from group consisting of PCMM; PCEM; and any mixtures thereof, wherein the amount of mercapto based compound is less than 0.5% by weight based on the total amount of filtered solid.

22) A phthalimide-based fungicide composition comprising phthalimide-based fungicide technical material with neutralized odor prepared by a process as claimed in any one of claims 1-19.
